(19) United States
(12) Patent Application Publication
(10) Pub. No.: US 2024/0310810 A1
(43) Pub. Date: Sep. 19, 2024

(54) Production Process Management System

(71) Applicant: SEIKO EPSON CORPORATION, Tokyo (JP)

(72) Inventors: Kosuke ATSUTA, Shiojiri (JP); Soji SHIOZAWA, Matsumoto (JP)

(21) Appl. No.: 18/606,391

(22) Filed: Mar. 15, 2024

(30) Foreign Application Priority Data
Mar. 16, 2023 (JP) 2023-041564

(51) Int. Cl. G05B 19/4063

(52) U.S. Cl. CPC G05B 19/4063; G05B 2219/32368

(57) ABSTRACT

A production process management system includes a first acquiring unit configured to acquire reason classification information that is information concerning a reason why an exceptional process different from a standard process was implemented in production of a molded product, a second acquiring unit configured to acquire reason identification information that is identification information of the reason classification information, a storage unit configured to store the reason classification information acquired by the first acquiring unit and the reason identification information acquired by the second acquiring unit in correlation with each other, and a receiving unit configured to receive selection of the reason classification information or the reason identification information when the exceptional process is implemented. Information concerning the exceptional process and the reason classification information or the reason identification information received by the receiving unit are stored in correlation with each other in the storage unit.

The present application is based on, and claims priority from JP Application Serial Number 2023-041564, filed Mar. 16, 2023, the disclosure of which is hereby incorporated by reference herein in its entirety.

### BACKGROUND

### 1. Technical Field

The present disclosure relates to a production process management system.

### 2. Related Art

JP-A-2016-124259 (Patent Literature 1) discloses an industrial machine. In the industrial machine, an image of a maintenance part of an injection molding machine and a comment of a user are stored in a storage unit in correlation with each other.

When having implemented an exceptional process different from standard processes in production of a molded product such as a process for performing maintenance of an injection molding machine or a process for discarding a molded product determined as a defective product in an inspection, a user sometimes causes a production process management system to store, as a comment, a reason for having implemented the exception process. When the reason why the exceptional process has been implemented is stored as the comment, even if the exceptional process has been implemented because of the same reason, content and a format of a described comment are likely to be different depending on a user. Therefore, it has been difficult to analyze a reason why the exceptional process has been implemented.

### SUMMARY

According to a first aspect of the present disclosure, a production process management system is provided. The production process management system includes: a first acquiring unit configured to acquire reason classification information that is information concerning a reason why an exceptional process different from a standard process was implemented in production of a molded product; a second acquiring unit configured to acquire reason identification information that is identification information of the reason classification information; a storage unit configured to store the reason classification information acquired by the first acquiring unit and the reason identification information acquired by the second acquiring unit in correlation with each other; and a receiving unit configured to receive selection of the reason classification information or the reason identification information when the exceptional process is implemented. Information concerning the exceptional process and the reason classification information or the reason identification information received by the receiving unit are stored in correlation with each other in the storage unit.

### BRIEF DESCRIPTION OF THE DRAWINGS

FIG. 1 is an explanatory diagram showing a schematic configuration of a production process management system.

FIG. 2 is a process chart of reason addition processing executed by the production process management system.

FIG. 3 is a diagram showing a reason list screen.

FIG. 4 is a diagram showing a reason addition screen.

FIG. 5 is a process chart of reason changing processing.

FIG. 6 is a diagram showing a reason changing screen.

FIG. 7 is a process chart of maintenance reason input processing executed by the production process management system.

FIG. 8 is a diagram showing a maintenance reason selection screen.

FIG. 9 is a process chart of exceptional process implementation reason input processing executed by the production process management system.

FIG. 10 is a diagram showing an exceptional process implementation reason selection screen.

### DESCRIPTION OF EMBODIMENTS

### A. First Embodiment

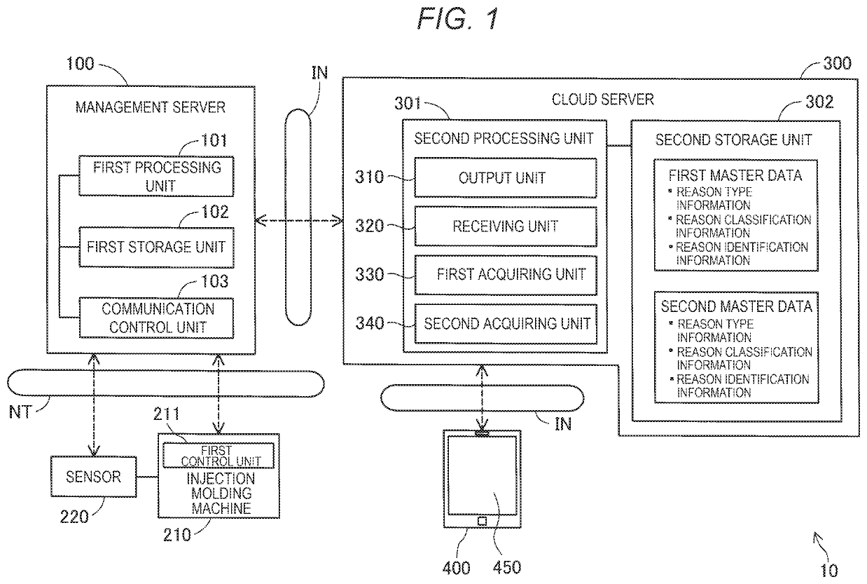

FIG. 1 is an explanatory diagram showing a schematic configuration of a production process management system 10. The production process management system 10 includes a management server 100, an injection molding machine 210, a sensor 220, a Cloud server 300, and a terminal device 400. The management server 100 is configured to be capable of communicating with the injection molding machine 210 and the sensor 220 each other via a network NT. For example, the network NT may be a LAN, may be a WAN, or may be the Internet. The Cloud server 300 is configured to be capable of communicating with the management server 100 and the terminal device 400 with each other via the Internet IN. Note that, in FIG. 1, an example is shown in which the production process management system 10 includes one injection molding machine 210 and one sensor 220. However, the production process management system 10 may include a plurality of injection molding machines 210 and a plurality of sensors 220. The production process management system 10 may include a take-out robot that takes out a molded product from the injection molding machine 210 and peripheral equipment such as a drier that dries materials used in the injection molding machine 210 and an inspection device that inspects a molded product molded by the injection molding machine 210.

The injection molding machine 210 is an apparatus that performs injection molding. The injection molding machine 210 includes a first control unit 211 and an injection device and a clamping device, both of which are not shown in FIG. 1. A molding die including a cavity is attached to the clamping device. The molding die may be made of metal, may be made of ceramic, or may be made of resin. The molding die made of metal is called metal mold. The first control unit 211 is configured by a computer including one or a plurality of processors, a storage device, and an input and output interface for performing input and output of signals from and to the outside. The first control unit 211 may be configured by a plurality of computers.

The first control unit 211 controls the units of the injection molding machine 210 to perform injection molding based on molding conditions acquired from the Cloud server 300 via the management server 100 and molds a molded product. More specifically, the first control unit 211 controls the clamping device to clamp the molding die and controls the injection device to inject a shaping material obtained by plasticizing a material to the molding die to thereby mold a molded product having a shape corresponding to the shape of the cavity provided in the molding die.

The sensor 220 measures an injection pressure, the temperature of the metal mold, an injection filling time, and the like, which are physical quantities concerning an operation state of the injection molding machine 210. The sensor 220 is, for example, a pressure sensor that measures the injection pressure, a temperature sensor that measures the temperature of the metal mold, and the like. The sensor 220 transmits the measured physical quantities concerning the operation state of the injection molding machine 210 to the management server 100. The sensor 220 may be included in the injection molding machine 210. The sensor 220 may transmit the physical quantities concerning the operation state of the injection molding machine 210 to the management server 100 via the first control unit 211 of the injection molding machine 210.

The management server 100 is configured by a computer including a first processing unit 101, a first storage unit 102, and a communication control unit 103. The first processing unit 101 includes one or a plurality of processors and a main storage device. The first storage unit 102 is configured by an auxiliary storage device such as a hard disk drive. The communication control unit 103 includes a communication circuit for controlling communication with other devices such as the Cloud server 300, the injection molding machine 210, and the sensor 220. The management server 100 may be configured by a plurality of computers. A display device such as a liquid crystal display and input devices such as a keyboard and a mouse may be connected to the management server 100.

The first processing unit 101 acquires the physical quantities concerning the operation state of the injection molding machine 210 transmitted from the sensor 220. The physical quantities concerning the operation state of the injection molding machine 210 acquired by the first processing unit 101 are stored in the first storage unit 102. The first processing unit 101 may transmit the physical quantities concerning the operation state of the injection molding machine 210 to the Cloud server 300. In this case, the physical quantities concerning the operation state of the injection molding machine 210 are stored in a second storage unit 302 of the Cloud server 300.

The terminal device 400 is configured as a computer including a CPU, a storage device, and a display unit 450. As the terminal device 400, for example, a tablet terminal, a notebook personal computer, a smartphone, and a handy terminal can be applied. Various screens output from the Cloud server 300 are displayed on the display unit 450. The display unit 450 may include a touch panel function. The terminal device 400 is referred to as information terminal as well.

The Cloud server 300 is a server used through the Internet IN. The Cloud server 300 includes a second processing unit 301 and a second storage unit 302. The first storage unit 102 of the management server 100 and the second storage unit 302 of the Cloud server 3 are collectively referred to as storage unit. Note that the management server 100 and the Cloud server 300 may be configured as one server.

A plurality of master data are stored in the second storage unit 302. The respective master data include reason type information, reason classification information, and reason identification information. In FIG. 1, an example is shown in which two master data including first master data and second master data are stored in the second storage unit 302. However, three or more master data may be stored in the second storage unit 302.

The reason type information is information concerning a type of an exceptional process that is a process different from standard processes in production of a molded product. The reason classification information is information concerning a reason why the exceptional process has been implemented. The reason identification information is identification information of the reason classification information. Details of the respective kinds of information are explained below.

The exceptional process is a process other than standard processes that are processes standard in production of a molded product.

The standard processes are, for example, a receiving process, a drying process, an arrangement process, a molding process, an inspection process, and a shipment process. The receiving process is a process for receiving, in a factory that produces the molded product, materials used for molding of the molded product and components configuring the molded product. In the receiving process, processing for inspecting materials and components supplied from a supply source to the factory and dispensing processing for taking out materials and components from a storage warehouse are executed. The drying process is a process for drying the materials used for the molding of the molded product. The arrangement process is a process for performing arrangement work for the injection molding machine 210. In the arrangement process, processing for putting the materials in a hopper of the injection molding machine 210 and processing for attaching a molding die to the injection molding machine 210 are executed. The molding process is a process for molding the molded product in the injection molding machine 210. The inspection process is a process for performing an inspection of the molded product molded by the injection molding machine 210. The shipment process is a process for packing the molded product and shipping the molded product to a shipment destination. Note that an insert product feeding process and a cleaning process may be included in the standard process depending on a molded product. The insert product feeding process is a process for attaching an insert product to the molding die when the molded product is molded by insert molding. The cleaning process is a process for cleaning the molded product.

The exceptional processes are, for example, a maintenance process, a discarding process, an inspection non-implementation process, and a quantity adjustment process.

The maintenance process is a process for performing maintenance of the units of the injection molding machine 210, the molding die, the peripheral equipment, and the like. The maintenance process is implemented, for example, when a defect has occurred in a molded product because of abnormalities of the injection molding machine 210, the molding die, and the peripheral equipment or is implemented in a period when periodical maintenance of the injection molding machine 210, the molding die, the peripheral equipment, and the like is performed.

The discarding process is a process for discarding the materials of the molded product and the molded product. The discarding process is implemented when a defect has been detected in the materials and when a defect has occurred in the molded product. Discarding the materials and the molded product is referred to as scrapping the materials and the molded product as well.

The inspection non-implementation process is a process for not implementing the inspection of the molded product molded by the injection molding machine 210. The inspection non-implementation process is implemented when it has been determined that the molded product has been determined as a defective product before the inspection of the molded product is performed, for example, when a defect has been detected in the materials used for the molding of the molded product or when an abnormality has been detected in a metal mold used for the molding of the molded product.

The quantity adjustment process is a process for adjusting a production quantity of the molded product on a system. For example, when the molded product has dropped in packing the molded product in the shipment process, the inspection process is sometimes implemented again for the dropped molded product. In such a case, the quantity adjustment process is implemented. On the system, a user reduces a quantity of the molded product that is in the shipment process and increases a quantity of the molded product that is in the inspection process. When it has been confirmed that a burr is present in the molded product, the molded product having the burr is sometimes removed from a production line of the molded product and returned to the production line after the burr is removed. In such a case as well, the quantity adjustment process is implemented. On the system, the user reduces a quantity of the molded product in the production line when the molded product is removed from the production line and increases the quantity of the molded product in the production line when the molded product is returned to the production line.

The reason type information is information concerning a type of the exceptional process. The reason type information is, for example, a metal mold maintenance reason, a material discarding reason, a shipment inspection denial reason, a shipment inspection cancellation reason, a lot present number adjustment reason, and a 4M change reason. The 4M change means changing a man, a machine, a material, and a method, which are four elements for producing a molded product. The man means a person involved in production of the molded product such as an operator who is in charge of operation of the injection molding machine 210 and an operator who is in charge of an inspection by the inspection device. The machine means a machine used for production of the molded product such as the injection molding machine 210, the drier, and the inspection device. The material means materials of the molded product. The method means a method of producing the molded product such as a method of injection molding, a method of taking out the molded product from a molding die, and a method of an inspection of the molded product.

The reason classification information is information concerning a reason why the exceptional process has been implemented. The reason classification information relates to one kind of reason type information. An example of the reason classification information is explained below.

When the reason type information is a metal mold maintenance reason, the reason classification information correlated with the reason type information is, for example, periodical metal mold overhaul, metal mold cleaning, a general inspection of a metal mold having a quality abnormality, and a partial inspection of the metal mold having the quality abnormality. The periodical metal mold overhaul means that overhaul of the metal mold has been executed when a shot for ejecting a shaping material to the metal mold has been executed a predetermined number of times or when a predetermined period has elapsed after use of the metal mold was stared. The metal mold cleaning means that cleaning of the metal mold has been performed. The general inspection of the metal mold having the quality abnormality means that all metal molds used for the molding of the molded product have been disassembled and inspected when a defect has been detected in the molded product. The partial inspection of the metal mold having the quality abnormality means that the metal mold used for the molding of the molded product has been partially disassembled and inspected when a defect has been detected in the molded product.

When the reason type information is the material discarding reason, the reason classification information correlated with the reason type information is, for example, a material defect or a molded product defect. The material defect means that a material has been discarded because a defect has been detected in the material. The molded product defect means that a material used for the molding of the molded product has been discarded because a defect has been detected in the molded product.

The shipment inspection denial reason is a reason for cancelling an inspection result determining that shipment is possible in a shipment inspection. When the reason type information is the shipment inspection denial reason, the reason classification information correlated with the reason type information is, for example, a reinspection or a molded product defect. The reinspection means that the inspection result is cancelled because the shipment inspection is implemented again. The molded product defect means that the inspection result is cancelled because a defect has occurred in the molded product after the inspection.

The shipment inspection cancellation reason is a reason for cancelling an implemented shipment inspection. When the reason type information is the shipment inspection cancellation reason, the reason classification information correlated with the reason type information is, for example a lot error or an input mistake. The lot error means that the implemented shipment inspection is cancelled because a lot different from a lot of a molded product that should be inspected has been inspected. The input mistake means that the implemented shipment inspection is cancelled because wrong information has been input to the inspection device.

The lot present number adjustment reason is a reason for adjusting, on a system, the numbers of lots of molded products present and lots of materials present in the factory. When the reason type information is the lot present number adjustment reason, the reason classification information correlated with the reason type information is, for example, inventory adjustment and product return adjustment. The inventory adjustment means that the numbers of lots of molded products and lots of materials present in the factory has been adjusted on the system because inventory has been implemented. The product return adjustment means that the number of molded products present in the factory has been adjusted on the system because a shipped molded product has been returned.

When the reason type information is the 4M change reason, the reason classification information correlated with the reason type information is, for example, metal mold overhaul, metal mold repairing, and device periodical maintenance. The metal mold overhaul means that a change of molding conditions has been implemented because overhaul of a metal mold has been executed. The metal mold repairing means that a change of molding conditions has been implemented because the metal mold has been repaired. The device periodical maintenance means that a change of molding conditions has been implemented because periodical maintenance of the injection molding machine 210 and the peripheral equipment has been implemented.

The reason identification information is identification information allocated to respective kinds of reason classification information. The reason identification information is, for example, ID numbers allocated to the respective kinds of reason classification information.

In the master data stored in the second storage unit 302, the reason type information, the reason classification information, and the reason identification information are stored in correlation with one another. That is, the reason type information, the reason classification information, and the reason identification information are stored in correlation with one another in the second storage unit 302.

Each of the master data includes one kind of reason type information. The reason classification information and the reason identification information included in each of the master data are the reason classification information and the reason identification information relating to the reason type information included in the same master data. In the following explanation, the reason type information included in the first master data is referred to as first reason type information as well. The reason type information included in the second master data is referred to as second reason type information as well. For example, when the first reason type information is the metal mold maintenance reason, the reason classification information included in the first master data is periodical metal mold overhaul, metal mold cleaning, general inspection of a metal mold having a quality abnormality, partial inspection of the mold having the quality abnormality, and the like. When the second reason type information is the material discarding reason, the reason classification information included in the second master data is a material defect, a molded product defect, and the like. In other words, the first master data includes the reason classification information and the reason identification information relating to the first reason type information. The second master data includes the reason classification information and the reason identification information relating to the second reason type information. That is, the master data of the reason classification information and the reason identification information is stored in the second storage unit 302 for each kind of the reason type information. Note that the master data may be stored not in the second storage unit 302 of the Cloud server 300 but in the first storage unit 102 of the management server 100. That is, the reason classification information, the reason identification information, and the reason type information may be stored in correlation with one another in the first storage unit 102.

The second processing unit 301 of the Cloud server 300 includes an output unit 310, a receiving unit 320, a first acquiring unit 330, and a second acquiring unit 340. The output unit 310, the receiving unit 320, the first acquiring unit 330, and the second acquiring unit 340 are implemented by the second processing unit 301 executing a program stored in the second storage unit 302. Note that these units may be implemented by circuits.

The output unit 310 outputs, to the terminal device 400, a screen operated by the user, for example, when the exceptional process has been implemented, when new reason classification information or reason identification information is stored in the second storage unit 302, or when the reason classification information or the reason identification information stored in the second storage unit 302 is changed. The screen output by the output unit 310 is displayed on the display unit 450 of the terminal device 400. Note that the output unit 310 may output the screen to the management server 100 and the injection molding machine 210.

The receiving unit 320 receives operation of the user on the screen output by the output unit 310.

The first acquiring unit 330 acquires the reason classification information.

The second acquiring unit 340 acquires the reason identification information.

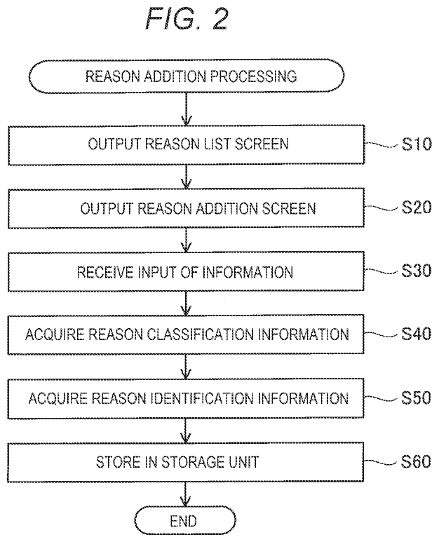

FIG. 2 is a process chart of reason addition processing executed by the production process management system 10. The reason addition processing is executed when predetermined operation has been performed on the production process management system 10.

In step S10, the output unit 310 outputs a reason list screen SC1 on which the reason classification information stored in the second storage unit 302 is displayed as a list. The reason list screen SC1 is displayed on the display unit 450 of the terminal device 400.

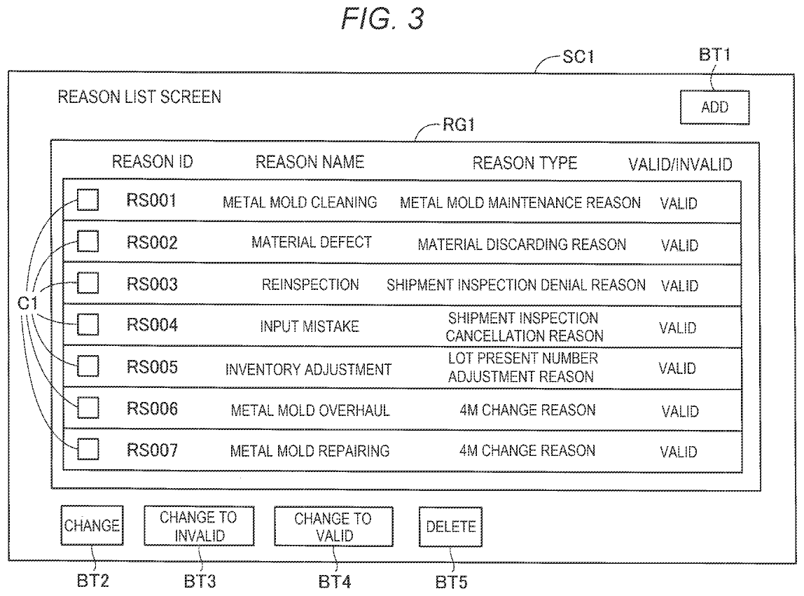

FIG. 3 is a diagram showing a reason list screen SC1. On the reason list screen SC1, a reason display region RG1, an addition button BT1, a change button BT2, an invalid button BT3, a valid button BT4, and a deletion button BT5 are provided. In the reason display region RG1, a reason ID, which is the reason identification information, a reason name, which is the reason classification information, stored in correlation with the reason ID, a reason type, which is the reason type information, stored in correlation with the reason ID and the reason name, and valid and invalid determination are displayed in rows. The valid and invalid determination is information used in reason input processing explained below to determine whether the respective kinds of reason identification information and the respective kinds of reason classification information can be selected by the user. The valid and invalid determination indicates valid or invalid. In the reason display region RG1, the reason identification information, the reason classification information, and the reason type information included in the master data stored in the second storage unit 302 are displayed as a list. That is, in the reason display region RG1, the reason identification information and the reason classification information included in the first master data and the reason identification information and the reason classification information included in the second master data are displayed as a list. In the reason display region RG1, checkboxes C1 associated with the reason identification information and the reason classification information displayed in the rows are provided.

In step S20 in FIG. 2, the output unit 310 outputs a reason addition screen SC2, which is a screen for the user to add new reason classification information and reason identification information to the master data. When the addition button BT1 has been clicked on the reason list screen SC1 shown in FIG. 3, the output unit 310 outputs the reason addition screen SC2 to the terminal device 400.

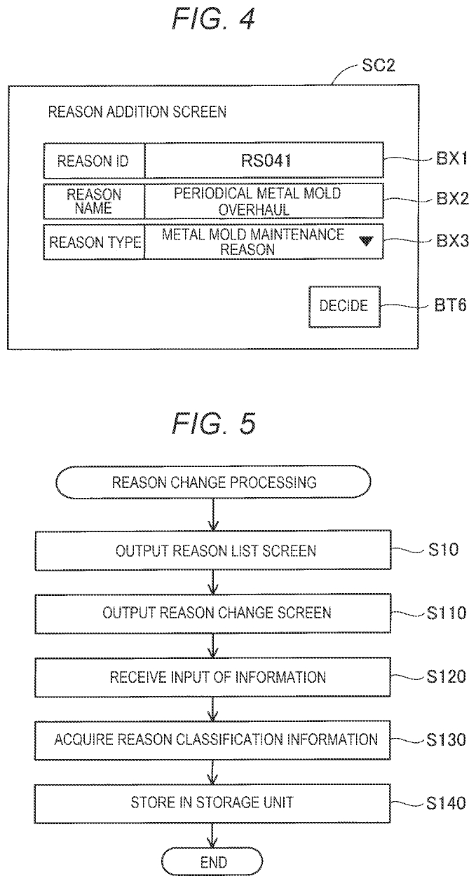

FIG. 4 is a diagram showing the reason addition screen SC2. On the reason addition screen SC2, a reason identification information input field BX1, a reason classification information input field BX2, a reason type selection field BX3, and a decision button BT6 are provided. The reason identification information is input to the reason identification information input field BX1 from the user. The reason classification information is input to the reason classification information input field BX2 from the user. The reason type selection field BX3 is provided such that the reason type information included in the master data stored in the second storage unit 302 is displayed by the user clicking the reason type selection field BX3.

In step S30 in FIG. 2, the receiving unit 320 receives input of information to the reason addition screen SC2. The user inputs the reason identification information to the reason identification information input field BX1, inputs the reason classification information to the reason classification information input field BX2, selects the reason type information in the reason type selection field BX3, and, thereafter, clicks the decision button BT6 on the reason addition screen SC2 shown in FIG. 4.

In step S40 in FIG. 2, the first acquiring unit 330 acquires, as the reason classification information, content input to the reason classification information input field BX2 of the reason addition screen SC2 shown in FIG. 4.

In step S50 in FIG. 2, the second acquiring unit 340 acquires, as the reason identification information, content input to the reason identification information input field BX1 of the reason addition screen SC2 shown in FIG. 4.

In step S60 in FIG. 2, the second processing unit 301 causes the second storage unit 302 to store the reason classification information acquired in step S40, the reason identification information acquired in step S50, and the reason type information selected in the reason type selection field BX3 of the reason addition screen SC2 in correlation with one another. In other words, the second processing unit 301 adds the reason classification information acquired in step S40 and the reason identification information acquired in step S50 to the master data including the reason type information selected in the reason selection field BX3 of the reason addition screen SC2. The reason addition processing is executed as explained above.

FIG. 5 is a process chart of the reason changing processing. The reason changing processing is executed when predetermined operation has been performed on the production process management system 10. Note that portions where the same processing as the reason addition processing shown in FIG. 2 are denoted by the same reference numerals and signs and explanation of the portions is omitted.

In step S110, the output unit 310 outputs a reason changing screen SC3, which is a screen for the user to change the master data. In a state in which the checkboxes C1 corresponding to any reason identification information and reason classification information are selected on the reason list screen SC1 shown in FIG. 3, when the change button BT2 has been clicked, the output unit 310 outputs the reason changing screen SC3 to the terminal device 400.

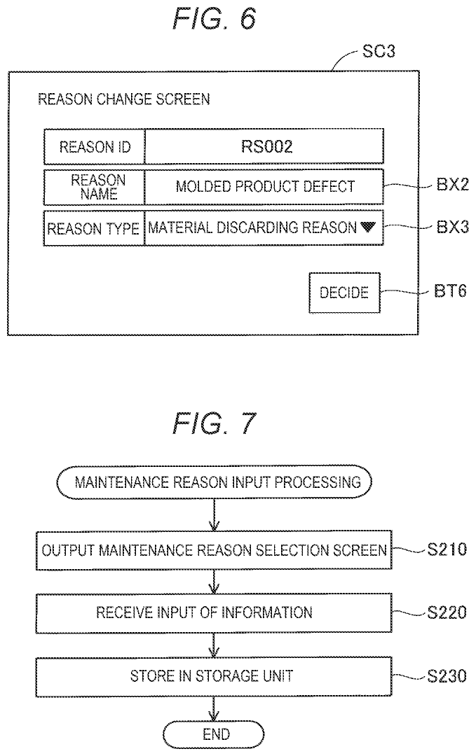

FIG. 6 is a diagram showing the reason changing screen SC3. On the reason changing screen SC3, the reason identification information selected on the reason list screen SC1 is displayed. On the reason changing screen SC3, the reason classification information input field BX2, the reason type selection field BX3, and the decision button BT6 are provided.

In step S120 in FIG. 5, the receiving unit 320 receives input of information to the reason changing screen SC3. The user deletes content displayed in the reason classification information input field BX2 and, thereafter, inputs reason classification information after change to the reason classification information input field BX2 on the reason change screen SC3 shown in FIG. 6. The user selects a reason type after change in the reason type selection field BX3. The user changes the content displayed in the reason classification information input field BX2 or the reason type selection field BX3 as explained above and, thereafter, clicks the decision button BT6.

In step S130 in FIG. 5, the first acquiring unit 330 acquire, as the reason classification information, the content input to the reason classification information input field BX2 of the reason changing screen SC3 in step S120.

In step S140 in FIG. 5, the second processing unit 301 causes the second storge unit 302 to store the reason identification information displayed on the reason changing screen SC3, the reason classification information acquired in step S130, and the reason type information selected in the reason type selection field BX3 of the reason changing screen SC3 in step S120 in correlation with one another. In other words, the second processing unit 301 changes the reason classification information and the reason type information stored in the second storage unit 302 in correlation with the reason identification information displayed on the reason changing screen SC3. The reason changing processing is executed as explained above.

In the following explanation, processing for changing the valid and invalid determination for the reason identification information and the reason classification information stored in the second storage unit 302 and processing for deleting the reason identification information and the reason classification information stored in the second storage unit 302 are explained with reference to FIG. 3.

In a state in which the checkboxes C1 corresponding to the reason identification information and the reason classification information determined as valid by the valid and invalid determination are selected on the reason list screen SC1, when the invalid button BT3 has been clicked, the second processing unit 301 changes the valid and invalid determination for the selected reason identification information and the selected reason classification information to invalid and causes the second storage unit 302 to store the valid and invalid determination after the change. In a state in which the checkboxes C1 corresponding to the reason identification information and the reason classification information determined as invalid by the valid and invalid determination are selected on the reason list screen SC1, when the valid button BT4 has been clicked, the second processing unit 301 changes the valid and invalid determination for the selected reason identification information and the selected reason classification information to valid and causes the second storage unit 302 to store the valid and invalid determination after the change. In a state in which the checkboxes C1 corresponding to any reason identification information and reason classification information are selected on the reason list screen SC1, when the deletion button BT5 has been clicked, the second processing unit 301 deletes the selected reason identification information and the selected reason classification information from the second storage unit 302.

FIG. 7 is a process chart of maintenance reason input processing executed by the production process management system 10. The maintenance reason input processing is executed when predetermined operation has been performed on the production process management system 10 when the maintenance process, which is the exceptional process, has been implemented.

In step S210, the output unit 310 outputs a maintenance reason selection screen SC4, which is a screen on which the user selects a reason why the maintenance process has been implemented. The maintenance reason selection screen SC4 is displayed on the display unit 450 of the terminal device 400. The maintenance reason selection screen SC4 is referred to as reason selection screen as well.

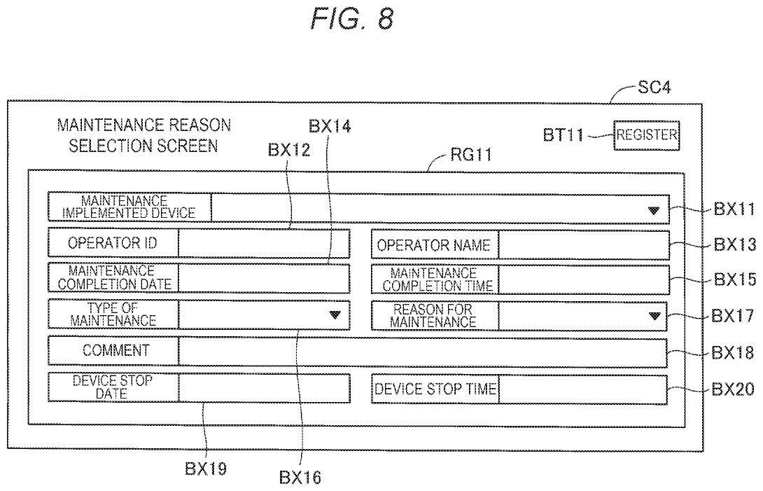

FIG. 8 is a diagram showing the maintenance reason selection screen SC4. In the maintenance reason selection screen SC4, a registration button BT11 and a reason input region RG11 are provided.

In the reason input region RG11, an input field BX11 to an input field BX20 are provided. A name of a device for which maintenance has been implemented is input to the input field BX11. The input field BX11 is provided such that names of the injection molding machines 210 and the peripheral equipment included in the production process management system 10 are displayed when the user has clicked the input field BX11. For example, when maintenance of a specific injection molding machine 210 has been executed, the user inputs a name of the specific injection molding machine 210 to the input field BX11. An ID number of the user who has implemented the maintenance process is input to the input field BX12. A name of the user who has implemented the maintenance process is input to the input field BX13. A date when the maintenance process has been implemented is input to the input field BX14. Time when the maintenance process has been implemented is input to the input field BX15. The reason type information is input to the input field BX16. The input field BX16 is provided such that the reason type information included in the master data stored in the second storage unit 302 is displayed when the user has clicked the input field BX16. The reason classification information is input to the input field BX17. The input field BX17 is provided such that the reason classification information included in the master data including the reason type information selected in the input field BX16 is displayed when the user has clicked the input field BX17. The reason classification information displayed when the input field BX17 has been clicked is the reason classification information determined as valid by the valid or invalid determination. A comment concerning the implemented maintenance process is input to the input field BX18. A date when the device, the name of which is input to the input field BX11, has stopped is input to the input field BX19. Time when the device, the name of which is input to the input field BX11, has stopped is input to the input field BX20. Information input to the input fields excluding the input field BX16 and the input field BX17 among the input field BX11 to the input field BX20 is referred to as information concerning the exceptional processes as well.

Note that, on the maintenance reason selection screen SC4, not the reason classification information but the reason identification information may be input to the input field BX17. The input field BX17 may be provided such that, when the user has clicked the input field BX17, the reason identification information included in the master data including the reason type information selected in the input field BX16 is displayed.

In step S220 in FIG. 7, the receiving unit 320 receives input of information to the maintenance reason selection screen SC4. The user inputs the information explained above respectively to the input field BX11 to the input field BX20 and, thereafter, clicks the registration button BT11 on the maintenance reason selection screen SC4. At this time, the user selects the reason type information of the implemented maintenance process in the input field BX16. For example, when maintenance of a metal mold has been implemented, the user selects “metal mold maintenance reason” in the input field BX16. The user selects the reason classification information of the implemented maintenance process in the input field BX17. For example, when overhaul of the metal mold has been executed because a shot has been executed a predetermined number of times, the user selects “periodical metal mold overhaul” in the input field BX17. The receiving section 320 receives selection of the reason type information and the reason classification information on the maintenance reason selection screen SC4.

Note that, when the reason identification information is input to the input field BX17 on the maintenance reason selection screen SC4, the user selects the reason identification information of the implemented maintenance process in the input field BX17. For example, when overhaul of a metal mold has been executed because a shot has been executed a predetermined number of times, the user selects the reason identification information corresponding to “periodical metal mold overhaul” in the input field BX17. That is, the receiving unit 320 receives selection of the reason type information and the reason identification information on the maintenance reason selection screen SC4.

In step S230 in FIG. 7, the second processing unit 301 causes the second storage unit 302 to store the kinds of information respectively input to the input field BX11 to the input field BX20 of the maintenance reason selection screen SC4 in correlation with one another. That is, the second processing unit 301 causes the second storage unit 302 to store the information concerning the exceptional process, the reason type information received by the receiving unit 320, and the reason classification information or the reason identification information received by the receiving unit 320 in correlation with one another. The maintenance reason input processing is executed as explained above.

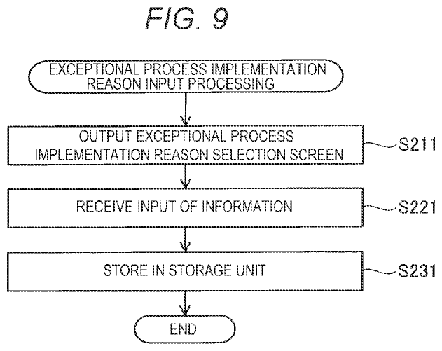

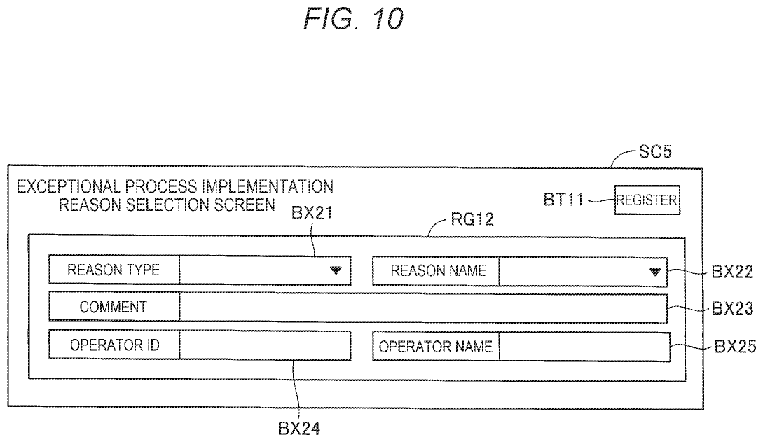

FIG. 9 is a process chart of exceptional process implementation reason input processing executed by the production process management system 10. The exceptional process implementation reason input processing is executed when predetermined operation has been performed on the production process management system 10 when an exceptional process other than the maintenance process has been implemented.

In step S211, the output unit 310 outputs an exceptional process implementation reason selection screen SC5 that is a screen on which the user selects a reason why the exceptional process other than the maintenance process has been implemented. The exceptional process implementation reason selection screen SC5 is displayed on the display unit 450 of the terminal device 400. The exceptional process implementation reason selection screen SC5 is referred to as reason selection screen as well.

FIG. 10 is a diagram showing the exceptional process implementation reason selection screen SC5. In the exceptional process implementation reason selection screen SC5, the registration button BT11 and a reason input region RG12 are provided.

In the reason input region RG12, an input field BX21 to an input field BX25 are provided. The reason type information is input to the input field BX21. The input field BX21 is provided such that the reason type information included in the master data stored in the second storage unit 302 is displayed when the user has clicked the input field BX21. The reason classification information is input to the input field BX22. The input field BX22 is provided such that the reason classification information included in the master data including e information selected in the input field BX21 is displayed when the user has clicked the input field BX22. The reason classification information displayed when the input field BX22 has been clicked is the reason classification information determined as valid by the valid and invalid determination. A comment concerning the implemented exceptional process is input to the input field BX23. An ID number of the user who has implemented the exceptional process is input to the input field BX24. A name of the user who has implemented the exceptional process is input to the input field BX25. Information input to the input field BX23 to the input field BX25 among the input field BX21 to the input field BX25 is referred to as information concerning the exceptional process as well.

Note that not the reason classification information but the reason identification information may be input to the input field BX22 on the exceptional process implementation reason selection screen SC5. The input field BX22 may be provided such that the reason identification information included in the master data including the reason type information selected in the input field BX21 is displayed when the user has clicked the input field BX22.

In step S221 in FIG. 9, the receiving unit 320 receives input of information to the exceptional process implementation reason selection screen SC5. The user inputs the information explained above respectively to the input field BX21 to the input field BX25 on the exceptional process implementation reason selection screen SC5 and, thereafter, clicks the registration button BT11. The user selects the reason type information of the implemented exceptional process in the input field BX21. For example, when the molding conditions have been changed, the user selects “4M change reason” in the input field BX21. The user selects the reason classification information of the implemented exceptional process. For example, when the molding conditions have been changed because repairing of a metal mold has been performed, the user selects “metal mold repairing” in the input field BX22. That is, the receiving unit 320 receives selection of the reason type information and the reason classification information on the exceptional process implementation reason selection screen SC5.

In step S231 in FIG. 9, the second processing unit 301 causes the second storage unit 302 to store the information respectively input to the input field BX21 to the input field BX25 of the exceptional process implementation reason selection screen SC5 in correlation with one another. That is, the second processing unit 301 causes the second storage unit 302 to store the information concerning the exceptional process, the reason type information, and the reason classification information or the reason identification information in correlation with one another. The exceptional process implementation reason input processing is executed as explained above.

With the production process management system 10 in the first embodiment explained above, the reason classification information and the reason identification information are stored in the storage unit in correlation with each other, when the exceptional process has been implemented, the reason selection screen on which the reason classification information or the reason identification information stored in the storage unit is displayed is displayed, and the reason classification information or the reason identification information selected on the reason selection screen is stored in the storage unit in correlation with the information concerning the implemented exceptional process. Therefore, when the exceptional process has been implemented because of the same reason, even if a different user causes the production process management system 10 to store a reason why the exceptional process has been implemented, it is possible to make it easy for the reason classification information or the reason identification information to be selected on the reason selection screen. Therefore, in this embodiment, compared with when the reason why the exceptional process has been implemented is stored in the production process management system 10 as a comment, it is possible to prevent an implementation reason for the exceptional process stored in the production process management system 10 from being different depending on a user. As a result, it is possible to facilitate an analysis of the reason why the exceptional process has been implemented.

In this embodiment, in the reason addition processing shown in FIG. 2, the reason classification information acquired by the first acquiring unit 330 and the reason identification information acquired by the second acquiring unit 340 are stored in the storage unit in correlation with each other. Therefore, the user can add new reason classification information and reason identification information in the master data stored in the storage unit.

In this embodiment, in the reason addition processing, the kinds of reason classification information included in the master data are displayed as a list on the reason list screen SC1 shown in FIG. 3. Therefore, when the user adds reason classification information to the master data, the user can check the reason classification information included in the master data, that is, the reason classification information already stored in the storage unit. Therefore, it is possible to prevent the user from causing the storage unit to store reason classification information having the same name as a name of the reason classification information already stored in the storage unit.

In this embodiment, in the reason addition processing, the reason classification information included in the first master data and the reason classification information included in the second master data are displayed as a list on the reason list screen SC1. Therefore, it is possible to prevent the user from adding, to the second master data, reason classification information having the same name as a name of the reason classification information included in the first master data. It is possible to prevent the user from adding, to the first master data, reason classification information having the same name as a name of the reason classification information included in the second master data.

In this embodiment, the reason type information is displayed on the reason list screen SC1. Therefore, the user can check to which reason type information the reason classification information and the reason identification information displayed on the reason list screen SC1 relate. Therefore, the user can easily recognize to which exceptional process the reason classification information and the reason identification information displayed on the reason list screen SC1 correspond.

### B. Other Embodiments

(B-1) In the embodiment explained above, the reason type information is displayed on the reason list screen SC1 shown in FIG. 3. In contrast, the reason type information may not be displayed on the reason list screen SC1.
(B-2) In the embodiment explained above, the reason type information is stored in the second storage unit 302. In contrast, the reason type information may not be stored in the second storage unit 302. In this case, master data may not be stored in the second storage 302 for each of reason types. The reason classification information and the reason identification information only have to be stored in correlation with each other in the second storage unit 302.
(B-3) In the embodiment explained above, in step S50 of the reason addition processing shown in FIG. 2, the second acquiring unit 340 acquires the reason identification information input to the reason identification information input field BX1 of the reason addition screen SC2 shown in FIG. 4. In contrast, in step S30 of the reason addition processing, when the reason classification information is input to the reason classification information input field BX2 of the reason addition screen SC2, the second processing unit 301 may generate the reason identification information. In this case, in step S50 of the reason addition processing, the second acquiring unit 340 acquires the reason identification information generated by the second processing unit 301.
(B-4) In the embodiment explained above, the second processing unit 301 of the Cloud server 300 includes the output unit 310, the receiving unit 320, the first acquiring unit 330, and the second acquiring unit 340. In contrast, the first processing unit 101 of the management server 100 may include a part or all of the output unit 310, the receiving unit 320, the first acquiring unit 330, and the second acquiring unit 340.

### C. Other Aspects

The present disclosure is not limited to the embodiments explained above and can be implemented in various aspects in a range not departing from the gist of the present disclosure. For example, the present disclosure can be implemented by the following aspects. Technical feature in the embodiments explained above corresponding to technical features in the aspects described below can be substituted and combined as appropriate in order to solve a part or all of the problems of the present disclosure or in order to achieve a part or all of the effects of the present disclosure. Unless the technical features are explained as essential technical features in this specification, the technical features can be deleted as appropriate.
(1) According to an aspect of the present disclosure, a production process management system is provided. The production process management system includes: a first acquiring unit configured to acquire reason classification information that is information concerning a reason why an exceptional process different from a standard process was implemented in production of a molded product; a second acquiring unit configured to acquire reason identification information that is identification information of the reason classification information; a storage unit configured to store the reason classification information acquired by the first acquiring unit and the reason identification information acquired by the second acquiring unit in correlation with each other; and a receiving unit configured to receive selection of the reason classification information or the reason identification information when the exceptional process is implemented. Information concerning the exceptional process and the reason classification information or the reason identification information received by the receiving unit are stored in correlation with each other in the storage unit.

According to such an aspect, when the exceptional process has been implemented, the reason why the exceptional process has been implemented is selected from the reason classification information or the reason identification information stored in the storage unit. Therefore, when the exceptional process has been implemented because of the same reason, compared with when the reason why the exceptional process has been implemented is stored as a comment, it is possible to prevent an implementation reason of the exceptional process stored in the production process management system 10 from being different depending on a user. Therefore, it is possible to facilitate an analysis of the reason why the exceptional process has been implemented.
(2) In the aspect explained above, the exceptional process may include a maintenance process, a discarding process, an inspection non-implementation process, or a quantity adjustment process.

According to such an aspect, the user can select, from the reason classification information or the reason identification information stored in the storage unit, a reason why the maintenance process, the discarding process, the inspection non-implementation process, or the quantity adjustment process has been implemented.
(3) In the aspect explained above, the storage unit may store first master data and second master data, the first master data may include the reason classification information relating to first reason type information that is information concerning a type of the exceptional process, the second master data may include the reason classification information relating to second reason type information that is information concerning the type of the exceptional process and is different from the first reason type information, and the production process management system may further include an output unit configured to output a reason list screen on which the reason classification information included in the first master data and the reason classification information included in the second master data are displayed as a list.

According to such an aspect, it is possible to prevent the user from causing the storage unit to store reason classification information having the same name as a name of the reason classification information included in the first master data or reason classification information having the same name as a name of the reason classification information included in the second master data.
(4) In the aspect explained above, the first reason type information and the second reason type information may be displayed on the reason list screen.

According to such an aspect, the user can check reason type information relating to the reason classification information displayed on the reason list screen.

What is claimed is:

1. A production process management system comprising:
a first acquiring unit configured to acquire reason classification information that is information concerning a reason why an exceptional process different from a standard process was implemented in production of a molded product;
a second acquiring unit configured to acquire reason identification information that is identification information of the reason classification information;
a storage unit configured to store the reason classification information acquired by the first acquiring unit and the reason identification information acquired by the second acquiring unit in correlation with each other; and
a receiving unit configured to receive selection of the reason classification information or the reason identification information when the exceptional process is implemented, wherein
information concerning the exceptional process and the reason classification information or the reason identification information received by the receiving unit are stored in correlation with each other in the storage unit.

2. The production process management system according to claim 1, wherein the exceptional process includes a maintenance process, a discarding process, an inspection non-implementation process, or a quantity adjustment process.

3. The production process management system according to claim 1, wherein
the storage unit stores first master data and second master data,
the first master data includes the reason classification information relating to first reason type information that is information concerning a type of the exceptional process,
the second master data includes the reason classification information relating to second reason type information that is information concerning the type of the exceptional process and is different from the first reason type information, and
the production process management system further comprises an output unit configured to output a reason list screen on which the reason classification information included in the first master data and the reason classification information included in the second master data are displayed as a list.

4. The production process management system according to claim 3, wherein the first reason type information and the second reason type information are displayed on the reason list screen.
